(19) United States
(12) Patent Application Publication
(10) Pub. No.: US 2025/0356177 A1
(43) Pub. Date: Nov. 20, 2025

(54) NEURAL NETWORK USING DYNAMICALLY COMPRESSED AND DECOMPRESSED WEIGHTS

(71) Applicant: Royal Bank of Canada, Toronto (CA)

(72) Inventors: Yanshuai CAO, Toronto (CA); Yongchang HAO, Edmonton (CA); Lili MOU, Edmonton (CA)

(21) Appl. No.: 19/209,613

(22) Filed: May 15, 2025

Related U.S. Application Data
(60) Provisional application No. 63/647,844, filed on May 15, 2024.

(51) Int. Cl. G06N 3/0495; G06N 3/084

(52) U.S. Cl. CPC G06N 3/0495; G06N 3/084

(57) ABSTRACT

A method for training or performing inference using a neural network involves performing per-layer decompression and compression of neural network weights. More particularly, compressed weights are retrieved for a particular layer of the neural network. The weights correspond to neurons in the layer. The compressed weights are decompressed, and input data for that layer is subsequently processed using the decompressed weights. This dynamic decompression and recompression of weights allows memory, and in particular random access memory of graphical processing units, to be efficiently used.

### CROSS-REFERENCE TO RELATED APPLICATIONS

The present disclosure claims priority to and benefit of U.S. provisional patent application No. 63/647,844, entitled “NEURAL NETWORK USING DYNAMICALLY COMPRESSED AND DECOMPRESSED WEIGHTS”, the entirety of which is hereby incorporated by reference herein.

### TECHNICAL FIELD

The present disclosure is directed at methods, systems, and techniques for training or performing inference using a neural network having weights that are dynamically compressed and decompressed to facilitate efficient memory usage.

### BACKGROUND

Deep learning with neural networks has become the backbone of numerous artificial intelligence applications. The search for better performing networks is a longstanding topic in deep learning. Without modifying the design, scaling up the number of parameters (e.g., number of hidden dimensions or layers) has been demonstrated as an effective practice to boost the performance of neural networks of the same kind. This idea has been successfully applied to text, image, sound, and multi-modal tasks across a wide range of model architectures. Recently, the number of parameters in state-of-the-art models has exceeded 100 billion, and in some cases numbers in the trillions, in an effort to achieve better performance. For example, the number of parameters used in a transformer architecture is documented as being around 200 million in 2019, and had already increased to 175 billion by 2022, representing roughly 100× growth.

Hardware capacity is not keeping up with this growth. For example, the largest on-device memory of graphical processing units (GPUs) was 32 GB in 2017, and is 80 GB in 2024, representing only 2.5× growth. This hardware limitation translates to a limitation of the trainable model size, bottlenecking scaling capacity. Although this problem can be alleviated by using more GPUs and sharding the model across multiple devices, doing so introduces communication overhead among GPUs, meaning large-scale distributed training is less efficient than centralized training. Therefore, efficiently using memory is important in scaling up neural networks.

### SUMMARY

According to a first aspect, there is provided a method for training or performing inference using a neural network, the method comprising, for each of at least one layer of the neural network: retrieving compressed weights for the layer of the neural network, wherein the compressed weights correspond to neurons in the layer; decompressing the compressed weight to generate decompressed weights; processing input data for the layer using the neurons and the decompressed weights to generate output data for the layer; and after the processing, compressing the decompressed weights to generate the compressed weights.

The input data and the output data may be embeddings.

The input data and the output data may be backpropagating gradients.

The method may further comprise, while training the neural network: receiving uncompressed weights from an optimizer; and compressing the uncompressed weights to generate the compressed weights.

Each of the weights may be expressed using exponent bits and mantissa bits, and

the exponent bits may be compressed using entropy-based lossless compression.

The mantissa bits may be compressed using lossy compression.

The lossy compression may comprise truncating the mantissa.

The exponent bits for a plurality of the weights may share a single array when compressed, and the mantissa bits for the plurality of the weights may be respectively stored in a number of arrays corresponding to a number of the plurality of the weights.

According to another aspect, there is provided a method for implementing data compression for training or performing inference using a neural network, the method comprising, for each of at least one layer of the neural network: retrieving compressed weights for the layer of the neural network, wherein the compressed weights correspond to neurons in the layer; decompressing the compressed weights to generate decompressed weights; and processing input data for the layer using the neurons and the decompressed weights to generate output data for the layer.

During forward propagation, the input data may comprise input embeddings and the output data may comprise output embeddings

The input embeddings and the output embeddings may be used for generating neural network output.

During back propagation, the input data may comprise input gradients and the output data may comprise output gradients.

The input gradients and the output gradients may be used for updating the neural network.

The compressed weights and the decompressed weights may be floating point numbers.

The method may further comprise retrieving the decompressed weights of the neural network; splitting each of the decompressed weights into sign bits, exponent bits, and mantissa bits; compressing the exponent bits and/or the mantissa bits to generate the compressed weights; and storing the compressed weights for use during neural network operation.

The decompressed weights may be allocated to a temporary memory space only active during the operation of the layer.

The method may further comprise concatenating the decompressed weights into floating point numbers for the processing.

The method may further comprise labeling and/or storing input data and/or output data for back propagation.

The method may further comprise: updating the decompressed weights using an optimizer; compressing the decompressed weights to generate updated compressed weights; and updating the compressed weights using the updated compressed weights.

The method may further comprise splitting the decompressed weights into sign bits, exponent bits, and mantissa bits.

Each of the uncompressed weights may comprise exponent bits and mantissa bits, and each of the compressed weights may comprise exponent bits compressed using entropy-based lossless compression.

The compressed weights may comprise mantissa bits compressed using lossy compression.

The lossy compression may comprises truncating the mantissa.

The exponent bits for a plurality of the weights may share a single array when compressed, and the mantissa bits for the plurality of the weights may be respectively stored in a number of arrays corresponding to a number of the plurality of the weights.

The lossless compression may be performed using an asymmetric numeral system algorithm.

According to another aspect, there is provided a method for training a neural network, the method comprising, for each of at least one layer of the neural network: retrieving compressed weights for the layer of the neural network, wherein the compressed weights correspond to neurons in the layer; decompressing the compressed weights to generate decompressed weights; updating the decompressed weights using first gradients for the layer; and processing the first gradients for the layer using the neurons and the decompressed weights to generate second gradients for the layer; compressing the decompressed weights to generate updated compressed weights; and updating the compressed weights using the updated compressed weights.

The compressed weights may comprise compressed exponent bits.

According to another aspect, there is provided a method for performing inference using a neural network, the method comprising, for each of at least one layer of the neural network: retrieving compressed weights for the layer of the neural network, wherein the compressed weights correspond to neurons in the layer; decompressing the compressed weights to generate decompressed weights; and processing first embeddings input to the layer using the neurons and the decompressed weights to generate second embeddings for the layer, where the compressed weights comprise compressed exponent bits and/or compressed mantissa bits.

According to another aspect, there is provided a system for training or performing inference using a neural network, the system comprising at least one processing unit configured to perform the method as described above.

According to another aspect, there is provided at least one non-transitory computer readable medium having stored thereon computer program code that is executable by at least one processor and that, when executed by the at least one processor, causes the at least one processor to perform the method as described above.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIGS. 1A to 1E depict entropy structures of floating point numbers used as signs (FIG. 1C), exponents (FIGS. 1A and 1D) and mantissas (FIGS. 1B and 1E) of neural network weights, according to example embodiments.

FIG. 2A depicts a per-layer procedure for using compressed weights, according to an example embodiment.

FIG. 2B depicts different per-layer procedures for neural networks, according to example embodiments.

FIG. 2C depicts a procedure for using compressed weights in neural network operations, according to an example embodiment.

FIG. 3 depicts a per-layer procedure performed when updating weights of a neural network, according to an example embodiment.

FIGS. 4A to 4C depict application of a lossless compression scheme used to compress an exponent of a floating point number representing a neural network weight, according to an example embodiment.

FIGS. 5A to 5C depict application of a lossy compression scheme used to compress a mantissa of a floating point number representing a neural network weight, according to an example embodiment.

FIG. 6 depicts a graph representing tolerance for lossy compression, according to an example embodiment.

FIG. 7 depicts a computer system that may be used to implement a method for training or performing inference using a neural network having weights that are dynamically compressed and decompressed, according to an example embodiment.

FIG. 8A to 8D depict trade-offs between memory and performance for neural network operations, according to example embodiments.

FIGS. 9A and 9B depicts throughput of different neural network operations, according to example embodiments.

FIGS. 10A to 10C depict entropy structures of floating point numbers used as signs (FIG. 10A), exponents (FIG. 10B) and mantissas (FIG. 10C) of randomly initialized neural network weights, according to an example embodiment.

FIGS. 11A to 11D depict entropy structures of exponent bits in floating point numbers used as weights for different neural networks, according to example embodiments.

### DETAILED DESCRIPTION

Peak memory usage is dictated by three relatively independent components: the optimizer, the saved activations for back-propagation, and the model itself. For the optimizer, there are already memory-efficient optimizers achieving a sublinear space complexity [1, 2]; for the activations, memory can be saved by enabling activation checkpointing [3], which saves storage by recomputing forward activations during back-propagation. For the model parameters, there has not been an effective method to save memory while preserving the ability to train the model. Recently, [4] proposed quantized low-rank adaptation (QLoRA), which freezes the parameters using a 4-bit data type for a backbone pre-trained model. While significantly saving memory for the model, it imposed a constraint that the overall change of the model be low-rank, limiting the capacity of the model.

Some techniques for reducing the memory usage of neural networks include knowledge distillation and pruning. Further techniques include the quantization technique, which represents each parameter with fewer bits and often undertakes common approaches such as k-means-based quantization, linear quantization, and mixed precision quantization. In particular, when training data is available, one may incorporate the quantization into the training process to improve performance.

Further, it is theorized that memory savings are possible by training a subset of parameters such that the optimizer used during neural network training only stores information about a small set of trainable parameters. One notable example is low-rank adaptation (LoRA). However, such a practice can restrict the optimization space of parameters, and thus can lead to significant performance degradation. Moreover, low-rank methods are unsuitable for pre-training.

Described herein are methods, systems, and techniques to dynamically compress and decompress a neural network's weights during training or inference, thereby reducing memory requirements for processors (e.g., GPUs) running the neural network. This compression and decompression can be performed during training or inference. Generally speaking, the method (hereinafter referred to as the “dynamic compression method”) comprises, for each of at least one layer of the neural network, retrieving compressed weights for the layer of the neural network, wherein the compressed weights correspond to neurons in the layer; decompressing the compressed weight to generate decompressed weights; and processing input data for the layer using the neurons and the decompressed weights to generate output data for the layer. In some cases, for example in network training, after the processing, the method can further comprise compressing the decompressed weights to generate the compressed weights.

More specifically, in at least some example embodiments, each floating point representation of a weight is decomposed into three parts: the sign bit, the exponent bits, and the mantissa bits. The exponent bits are distributed in a low-entropy nature, and accordingly may be compressed using lossless compression, such as the asymmetric numerical system (“ANS”) [5], a lossless compression algorithm that achieves an extremely high throughput on parallel computing devices like GPUs. Since the compression is lossless, the memory reduction comes without compromising any precision loss and enables full-parameter training. In addition, the compression can save the communication cost in distributed training, potentially saving time when the inter-GPU (or inter-node) bandwidth is the bottleneck.

In addition to lossless compression for training, in at least some embodiments the dynamic compression method may also apply lossy compression for inference that further reduces a neural network's memory requirements. Specifically, the relative change of each parameter may be controlled by only storing the top-k significant bits of a weight's mantissa. Experimentally, it is also shown that in at least some embodiments the dynamic compression method lies at the Pareto frontier of the precision-memory trade off when compared with several state-of-the-art quantization baselines. Lossy mantissa compression may, in at least some embodiments, also be applied during training.

In at least some embodiments, the dynamic compression method treats each floating number data types following the IEEE-754 standard as three components: the sign bit, the exponent bits, and the mantissa bits. In other embodiments, floating number data types other than IEEE-754 may be used; for example, the sign bit may be dropped.

As discussed further below, it has been found that the exponent bits show a low-entropy feature, enabling entropy-based lossless compression algorithms like ANS (asymmetric numerical system). Compressing the exponents alone saves ˜30% memory usage of the model. Further, it has been found that the model parameters are insensitive to the relative perturbation, which directly translates to mantissa truncation. Combining both techniques, ˜75% memory savings may be achieved while preserving most of the neural network's performance.

Accordingly, the present disclosure is generally directed to a compression scheme for neural networks that can achieve memory-efficient training and inference. Utilizing floating-point structures, the disclosed method can compress the exponent in a lossless way and can compress the mantissa in a lossy way. The lossless compression may be applied to both training and inference while yielding the same result as an uncompressed model. The lossy compression can provide additional memory saving for inference to achieve superior memory-performance trade-off.

Note that in contrast to most quantization techniques, the present disclosure can be a zero-shot method as described further herein, and therefore, may be fairly compared to zero-shot quantization methods, which generally have poorer performance.

As used herein, performance can generally refer to the speed, accuracy, precision, power consumption, and other such aspects of neural networks and machine learning models.

Broadly, Shannon entropy is used to measure the “stochasticity” of a random variable with the following definition:

$$H ( X ) := {𝔼}_{x} [ - {log}_{2} p ( X ) ] \qquad ( 1 )$$

for a random variable X with probability p. The lower the entropy, the more deterministic the random variable will be. The entropy of a random variable also represents the minimum number of bits required in expectation to represent data points

$${\{ {x}_{i} \}}_{i = 1}^{n}$$

that are i.i.d. to X. Therefore, a low entropy H(X) directly corresponds to better compressibility of

$${\{ {x}_{i} \}}_{i = 1}^{n} .$$

In particular, a lower entropy indicates less stochasticity for a random variable. In fact, the entropy can equal the minimum number of bits required, in expectation, to represent a random variable, and therefore correspond to data compressibility.

Stochastic gradient descent (SGD) and its variants are the default optimization methods for deep learning. SGD is shown to have the implicit regularization effect on neural networks, meaning the model parameters are implicitly encouraged to have smaller magnitudes during training. In practice, explicit regularization is also applied for better generalization ability. For example, the weight decay technique reduces the magnitudes of weights at every update iteration. Similarly in Bayesian inference, prior distributions (e.g., Gaussian and Laplace distributions) are often applied, imposing a zero-concentrated preference over the parameters. Beyond the distributions of trained neural networks, the parameters are also initialized with Gaussian distribution for matrices. The foregoing leads to the observation that if the parameters of a model

$${\{ {w}_{i} \}}_{i = 1}^{d}$$

are i.i.d. to some random variable X_{w}, the entropy H(X_{w}) is likely to be low.

This observation can be explained by calculating the entropy. For a non-concentrating random variable with all possible values sharing an equal probability, the entropy of it reaches a maximum value of log₂n. Whereas for a highly-concentrating (e.g., fully deterministic) random variable, the entropy can be as low as 0.

As applied to neural networks, parameters (e.g., weights) in neural networks can exhibit low entropy. First, parameters are typically initialized with a Gaussian distribution for matrices. This encourages all weights to be centered around zero, effectively reducing the entropy (or randomness). In addition, regularization can often be applied for better generalization ability. For example, the weight decay technique reduces the magnitudes of weights at every update iteration. Similarly, in Bayesian inference, prior distributions (e.g., Gaussian and Laplace distributions) are often applied, thereby imposing a zero-concentrated preference over the parameters. Even without explicit regularization, SGD or its variants may have the implicit regularization effect on neural networks, indicating that the model parameters are implicitly encouraged to have smaller magnitudes during training. Based on the above effects and techniques, assuming neural network parameters are i.i.d. random variables, the entropy of the distribution is likely to be low. That is, the numerical values or representations of the neural network parameters/weights can have low entropy of distribution and can be relatively concentrated.

Note that, for storage or for use by a neural network, each parameter value can be handled in accordance with the IEEE 754 standard as floating point numbers. In this representation, each number is represented by three components: the sign bit, the exponent bits, and the mantissa (or fraction) bits.

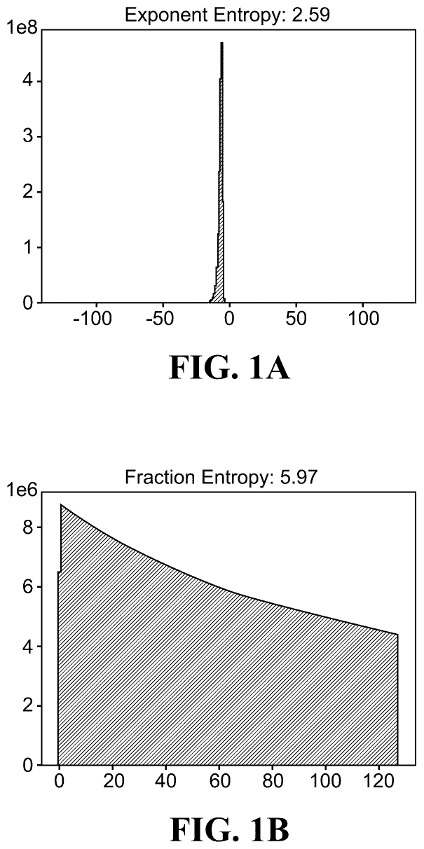

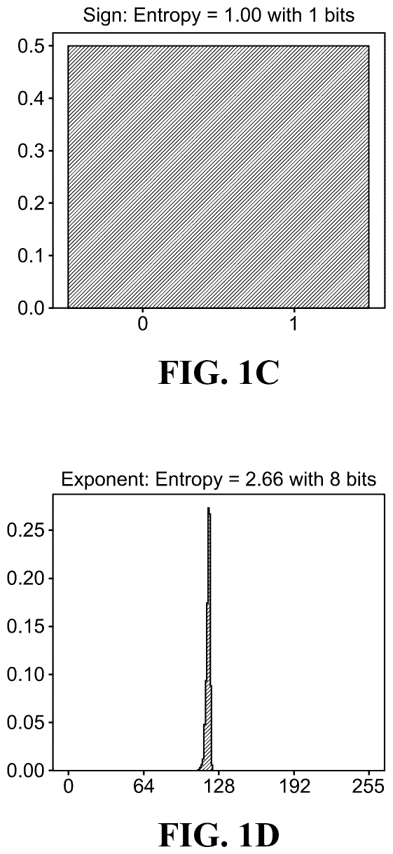

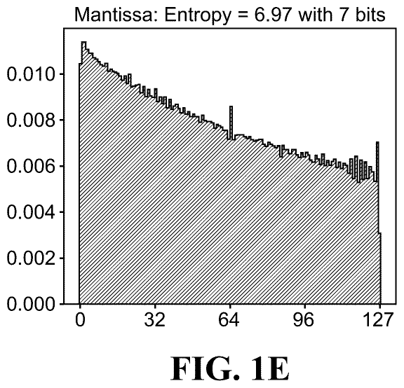

FIGS. 1A and 1B depict entropy structures of exponent bits of floating point numbers in neural network weights (FIG. 1A) and of mantissa bits of floating point numbers in neural network weights (FIG. 1B) for a Llama™ large language model (LLM), according to an example embodiment. Similarly, FIGS. 1C, 1D, and 1E depict entropy structures of the sign bits, the exponent bits, and the mantissa bits of floating point numbers in neural network weights for a Llama-3™ model, respectively. FIGS. 1A-1E are shown as histograms where the x-axes represent all possible binary values and the y-axes represent the frequency of each value.

As shown in FIGS. 1A-1E, it is clear that the exponents have low entropy, whereas the fraction/mantissa has high entropy. This difference is relevant for compression purposes. Specifically, as shown in FIG. 1C, the sign bit has a high entropy as it is evenly distributed; hence, it is not compressible. Each sign bit also only has only 1 bit with 2 possible values of 0 or 1 (corresponding to positive and negative, respectively) and is therefore relatively insignificant for memory usage considerations and would be impractical/feasible to compress. In contrast, for the exponent bits, there is a clear pattern in that they demonstrate a low-entropy nature. The exponent bits often carry less than 3 bits of information but are utilized with 8 bits of capacity. Thus, the exponent bits can be highly under-utilized with respect to the carrying capacity, leading to inefficiencies in handling and utilization. In comparison, the mantissa bits exhibit high entropy. However, while the mantissa bits are in many cases utilized with 7-bit capacity, they can often store nearly 7 bits of information and are therefore utilized more fully with respect to the carrying capacity.

As mentioned above, model weights are represented by floating points corresponding or similar to the IEEE 754 standard. Each number is represented in three components: the sign bit, the exponent bits, and the mantissa bits. During model training, weight matrices stay in compressed form until needed for forward or backward computation, in which case the required matrix or matrices are decompressed for computation. Following the computation, the matrix or matrices can be compressed again or wiped, as the case may be, to save memory. Accordingly, the weights for the entire network are not all decompressed at any point in time.

More specifically, by compressing the exponents, it is possible to recover the overall optimal compression ratio. For the exponents of the weights depicted in FIGS. 1C-1E, an ideal compression algorithm may be able to achieve a ratio as high as 1.501, corresponding to the sum of the three entropy values, which is only marginally below the overall compression ratio 1.505.

It should be noted that while FIGS. 1A-1E pertain to trained/pre-trained networks, the same entropy distribution pattern can be generally seen in various networks at different stages, including untrained networks with randomly initialized weights. This can have practical technical effects on the training of the networks. For example, when a network or model is trained from scratch, the parameters are randomly initialized.

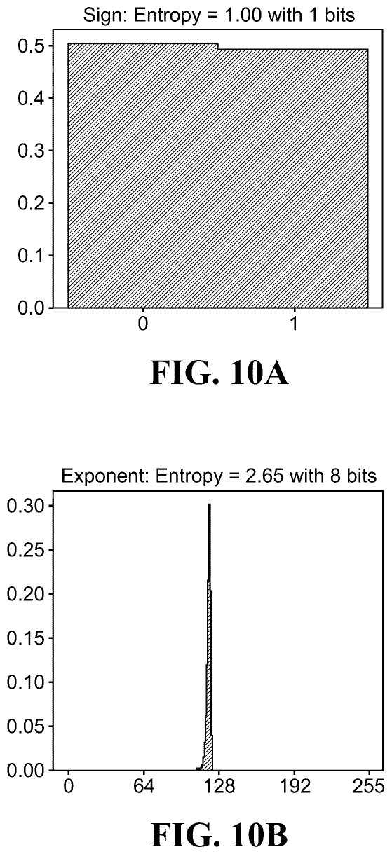

Referring now to FIGS. 10A-10C, entropy structures of the sign bits, the exponent bits, and the mantissa bits of floating point numbers in neural network weights for a Llama-3™ model with random initialization are respectively depicted, according to an example embodiment. The model referenced in FIGS. 10A-10C is initialized according to the standard Hugging Face™ procedure. FIGS. 10A-10C are shown as histograms where the x-axes represents all possible binary values and the y-axes represent the frequency of each value. As shown in FIGS. 10A-10C, the distribution entropy of the sign bit, exponent bits, and mantissa bits for a randomly initialized model (e.g., without training) show a similar pattern to that of a trained model (as depicted in FIGS. 1A-1E). As such, the compression methods disclosed herein can be generally applicable even for untrained models and models with randomly initialized weights. Advantageously, this indicates that the disclosed methods can be applied during model training (e.g., immediately after initialization) in addition to during inference.

Further, while FIGS. 1A-1E pertain to networks with a transformer-based architecture, the same distribution pattern can be generally seen in all types of networks, such as diffusion models. For example, the low-entropy distribution behavior of the exponent bits can be a common phenomenon observed in deep learning networks in general. As such, the methods disclosed herein can be advantageously applied for networks having various different architectures.

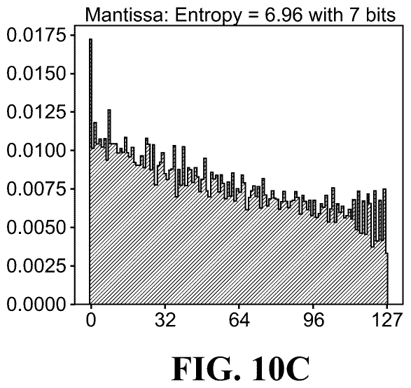

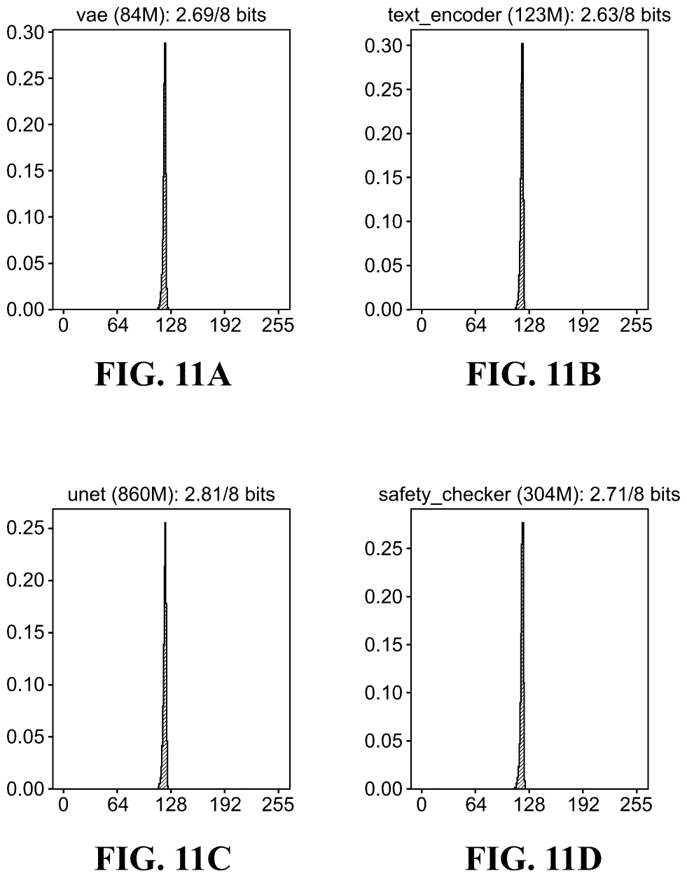

Referring now to FIGS. 11A-11D, entropy structures of the exponent bits of floating point numbers in neural network weights for a VAE (Variational Autoencoder) model, a text-encoder model, a U-net convolutional neural network, and a safety checker model are respectively depicted, according to example embodiments. FIGS. 11A-11D are shown as histograms where x-axes represent all possible binary values and the y-axes represent the frequency of each value. Note that the models referenced in FIGS. 11A-11D are four models utilized in a diffusion pipeline, which in this case is the Stable Diffusion™ model. As shown in FIGS. 11A-11D, these non-transformer based models also exhibit the same entropy distributions for the exponent bits representations of their respective weights. Accordingly, it is possible to generally apply the disclosed methods for most, if not all, types of deep learning models.

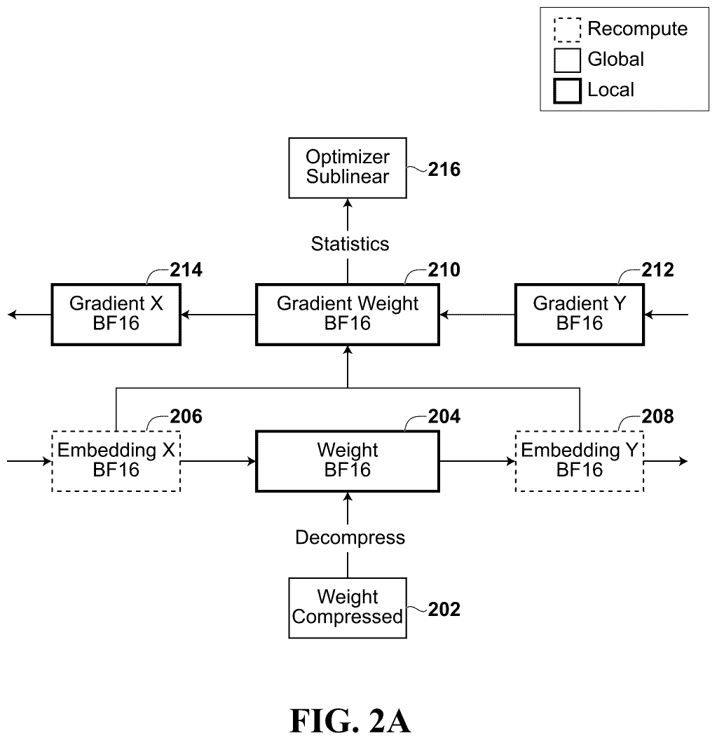

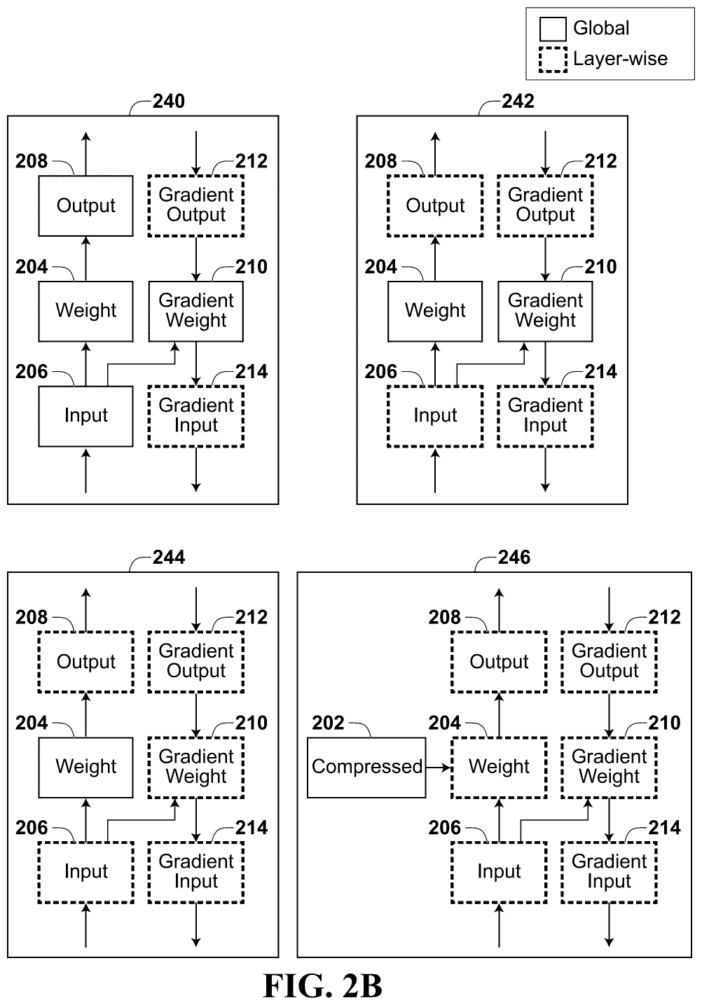

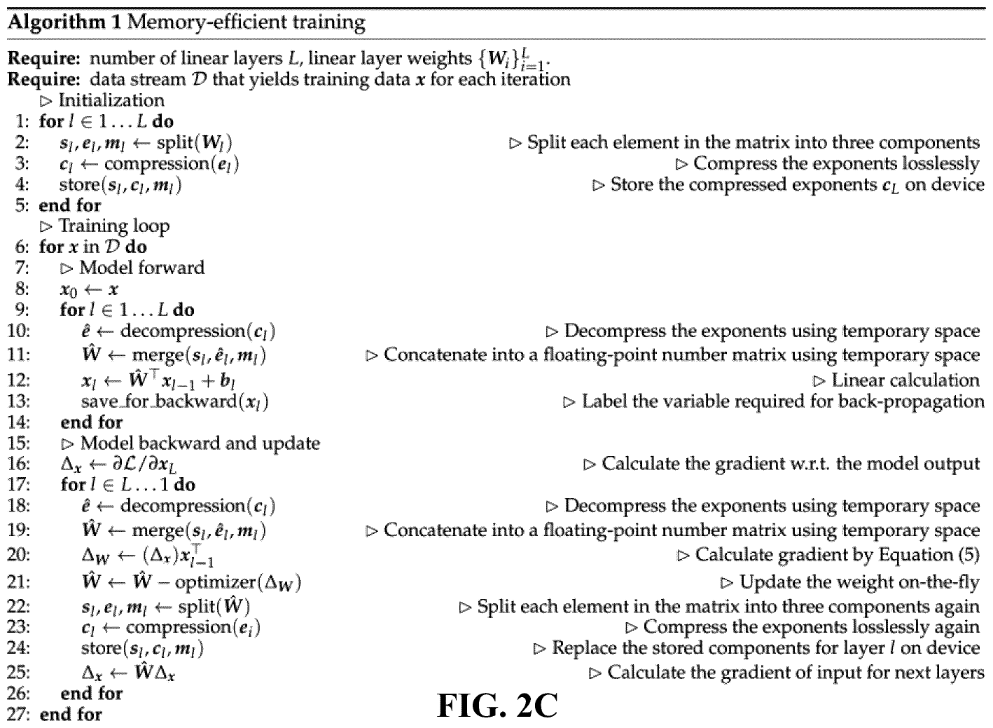

FIG. 2A depicts a per-layer procedure performed when determining gradients using autograd when training a neural network, according to an example embodiment. As described above, the number of bits that is used per exponent may be highly inflated compared to the information entropy. However, some research demonstrates that the dynamic range provided by the 8-bit exponents are critical for neural networks. Thus, the present disclosure aims to compress the exponent bits in a lossless manner based on the entropy. This practice mainly has three benefits: (1) increasing the throughput of compression as only parts of the bits are processed by the compression; (2) reducing the burden of maintaining the statistics of a large set of symbols (e.g., 256 symbols for 8-bit exponents versus 65,536 symbols for 16-bit representations), enabling greater efficiencies for compression algorithms; and (3) recovering most of the compressibility, for example, as shown in FIGS. 1A-1E.

Note that the compression of the weights (e.g., the sign, exponent, and mantissa bits) in and of itself does not necessarily save any memory for maintaining a single array (e.g., compressing the weights for storage only). This is because, for compression and decompression, at least one buffer of the same size as the uncompressed array is required. In the scope of neural networks, the whole model can often be prohibitively large; thus it can be infeasible to duplicate the memory corresponding to the array of weights. Therefore, the present disclosure aims to exploit the multi-layer structure of modern neural networks to avoid creating a large buffer.

During inference/training, the weights (e.g., the weight matrices) are loaded into memory for processing by an appropriate processing unit. The weights may be stored in suitable storage such as local or external storage (e.g., a database) when the network is not in use and be retrieved from that storage for inference and/or training. The processing unit may be any suitable processing units such as one or more central processing units (CPUs), GPUs, etc. The memory may be appropriately allocated for use during training/inference. For example, when processed by a CPU, the weights may be loaded into the random access memory (RAM); when processed by a GPU, the weights may be loaded into the video random access memory (VRAM). In some cases, the weights may be loaded into local memory.

More particularly and with respect to each layer of a network, during forward propagation, the compressed weights are obtained at block 202 and then decompressed, resulting in decompressed weights. Input data in the form of Embedding X is received at block 206 from a shallower layer of the network, processed by the neurons of a particular layer at block 204, with the output of that processing being Embedding Y at block 208 serving as input to a deeper layer. Gradient weights are determined from Embedding X and Embedding Y. Note that during forward propagation, the decompressed weights can be discarded or removed from active memory after being processed by the neurons at block 204. That is, while the weights for a particular layer are retrieved or accessed from block 202 and subsequently decompressed for processing, the decompressed weights are not persistent in memory and do not need to be returned to block 202. In some embodiments, the decompressed weights may be compressed and then returned to block 202 after processing by the neurons.

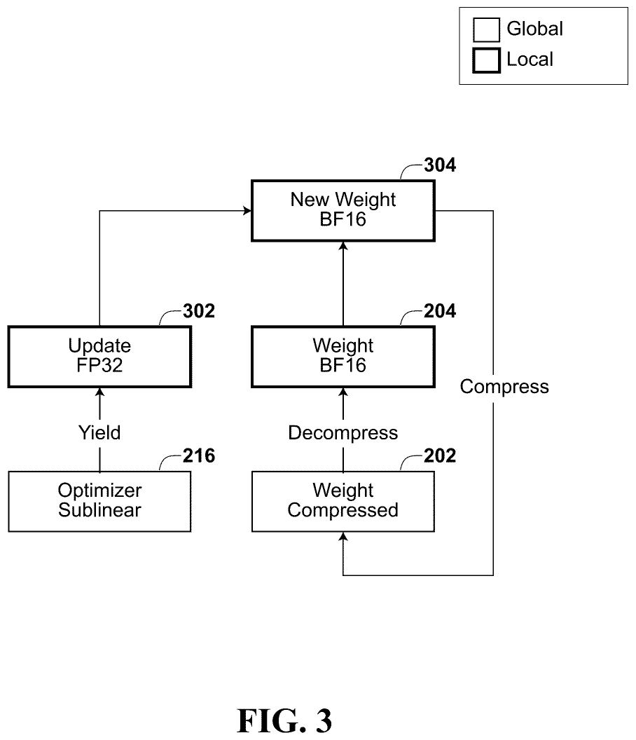

During back propagation, the gradient in the form of Gradient Y from block 212 is received from a deeper layer of the network. This gradient is scaled by the gradient weight at block 210, and the scaled gradient is fed to an optimizer at block 216, which generates updated weights for the layer as described further in respect of FIG. 3 below. The scaled gradient output from block 210 is Gradient X at block 214, which is fed to a successive shallower layer as part of back propagation.

The decompressed weights, gradient weight, gradients, and embeddings in this example are floating point numbers expressed in the BF16 format. Different numeric formats may be used in other embodiments.

More specifically, without loss of generality, consider the linear function as a common building block in neural networks at a particular layer l:

$${x}_{l} ← {W}_{l} {x}_{l - 1} + {b}_{l} , \qquad ( 2 )$$

where Wₗ∈ [symbol] ^{m×n} is the weight matrix, bₗ∈ [symbol] ^{m} is the bias vector of a layer l, and xₗ is the input of the layer l. One can modify the compressed forward pass in the following form:

$$\hat{W} ← decompress ( {c}_{l} ) \qquad ( 3 )$$

$${x}_{l} ← \hat{W} {x}_{l - 1} + {b}_{l} , \qquad ( 4 )$$

where cₗ is the compressed storage of the matrix Wₗ. In this way, it is only required to store cᵢ for each layer, thus leading to lower memory usage. During each forward pass, weight matrices stay in the compressed form until the original data is needed, in which case it is decompressed into a temporary space Ŵ for computation, as described above. As a result, the entire network is never fully decompressed at any point in time, making the overall forward pass memory efficient.

In some embodiments, although the forward pass is modified, the back-propagation for each linear layer is fully unaffected. This is because

$$\frac{\partial ℒ}{\partial {W}_{l}} = \frac{\partial ℒ}{\partial {x}_{l}} \frac{\partial {x}_{l}}{\partial {W}_{l}} = ( {∇}_{{x}_{l}} ℒ ) {x}_{l - 1}^{⊤} . \qquad ( 5 )$$

Therefore, one can obtain the gradient as long as the activations are saved. Similarly, the gradient of inputs can also be propagated with

$$\frac{\partial ℒ}{\partial {x}_{l - 1}} = \frac{\partial ℒ}{\partial {x}_{l}} \frac{\partial {x}_{l}}{\partial {x}_{l - 1}} = {( {∇}_{{x}_{l}} ℒ )}^{⊤} {W}_{l} , \qquad ( 6 )$$

where Wₗ can be constructed by decompression. Accordingly, the present disclosure is also compatible with activation checkpointing by recomputing the activations, therefore opening more opportunities for memory saving. Note that for weight updates, the matrix is decompressed into the original floating-point format and then compressed to update the matrix. This procedure is done in a layer-by-layer fashion, similar to Local Maximal Occurrence (LOMO). A detailed breakdown of this procedure is shown in FIG. 2C.

FIG. 3 depicts a per-layer procedure performed when updating weights of a neural network, according to an example embodiment. The procedure depicted in FIG. 3 begins with the output from the optimizer at block 216 in response to the optimizer receiving the scaled, backpropagating gradient as discussed above in respect of FIG. 2A. The optimizer outputs an update in FP32 format at block 302, and that update is used to calculate the new weights for the layer at block 304 based on the old weights retrieved from block 204 as described above. As shown, the pre-updated weights at block 204 are obtained by retrieving and decompressing the weights for the layer stored at block 202. The new weights are calculated in BF16 format. The weights calculated at block 304 (e.g., updated weights) are uncompressed weights, and they are subsequently compressed to save memory. The compressed weights are then returned to or used to update the weights for the layer which are stored at block 202. The uncompressed weights can then be removed or wiped from memory.

Subsequently, the (updated) compressed weights can be retrieved from block 202 for the next forward pass. Note that the above process described in respect of FIGS. 2A and 3 is repeated on a per-layer basis for the network. Specifically, as each layer is processed/utilized in sequence during model usage, only the weights corresponding to the specific layer being activated are retrieved/updated at any point in time from block 202. As the model proceeds to the next layer in sequence, the uncompressed weights for the current layer are compressed and updated (back propagation) or discarded (forward propagation), with the weights for the next layer being retrieved and subsequently decompressed for processing. Accordingly, only the weights for a single layer are decompressed at any point in time with the remainder of the weights remaining compressed and stored at block 202 to preserve memory. As such, a single layer's worth of weights are accessed at any point in time by the neural network.

In FIGS. 2A and 3, blocks 202 and 216 are labeled as “Global” to represent that the compressed weights and optimizer are persistent in memory for all layers of the neural network; blocks 204, 210, 212, 214, 302, and 304 are labeled as “Local” in that the memory allocated for the decompressed weights (block 204), gradient weight (block 210), gradients (blocks 212 and 214), update (block 302), and new weights (block 304) is temporarily allocated on a per-layer basis (i.e., that memory is re-allocated or re-used for new values of those parameters for other layers); and blocks 206 and 208 are labeled as “Recompute” in that memory for Embeddings X and Y is allocated on a per-layer basis as for “Local” variables, but are iteratively determined on a per-layer basis from saved activations for each layer.

The procedure of FIGS. 2A and 3 is also shown in 246 of FIG. 2B, which corresponds to FIG. 2A. With reference to 246 of FIG. 2B and FIG. 2C, the present disclosure can be implemented as follows. During model initialization, the initialized weights can be stored in a weights matrix. The weights may be in a floating point representation (e.g., IEEE-754). The matrices can be processed such that each element in the matrix, corresponding to an individual weight, can be split into the sign, exponent, and mantissa components, as described above. The components can then be compressed to update the matrices or to populate new matrices. The updated/new matrices can then be stored (e.g., in device/local storage). For example, the exponent bits (eₗ) can be compressed losslessly (cₗ) for storage until retrieval for training/inference. In particular, the compressed weights can be stored at block 202. Furthermore, weights may be stored by layer. For example, weights may be labeled by layer to better facilitate the retrieval of the weights of individual layers during network use.

Note that the generation and storage of the compressed weights are not limited for use with untrained models. In particular, uncompressed weights for trained or pre-trained models can be obtained/retrieved and analogously compressed and stored as described herein and subsequently used for inference, fine-tuning, etc.

Referring to 246, on a per layer basis, in forward propagation, input data in the form of embeddings X is received from a preceding layer (or as direct input for the initial layer) at block 206. To process the input data as to generate the output data in the form of embeddings Y for processing in the subsequent layer (or as direct output for the final layer), the compressed weights are retrieved from block 202. In particular, the compressed weights for the particular layer can be retrieved as one or more matrices by loading the compressed weights into memory. A temporary space (e.g., transitory memory) can be allocated for weight processing. At block 204, the compressed weights are decompressed for use by the network. For example, the compressed exponent bits (cₗ) can be decompressed to return the uncompressed exponent bits (eₗ). The uncompressed weights can be generated in the form of one or more matrices within the temporary space (Ŵ), for example by merging/concatenating the uncompressed sign, exponent, and mantissa bits into a floating point matrix in the temporary space. The uncompressed weights are used by the network to process the input data, for example by performing the required linear calculations. The output data, corresponding to the input data for the subsequent layer, can be saved along with any other variables for use during back propagation. These data may be labeled, for example to identify the particular layer (l) and/or the layer for which the weights need to be updated (e.g., the subsequent layer). Note that the saving of data (e.g., output data and/or variables) is only required during training (e.g., used for back propagation) and may be omitted during inference. Once output data is generated at 208, the temporary space can be wiped to save memory. Accordingly, the compressed weights are decompressed in a layer-by-layer manner for the forward pass.

For the backward pass, the input is recalculated again following the forward pass, similar to activation checkpointing. A linear operator can calculate the gradients for both the weight matrix and input, as described above with respect to FIG. 3. That is, the compressed weights are retrieved again for decompression, which are used to calculate the gradient of input. After the gradient is calculated, weights can be updated directly after compression without storing it.

Referring to 246, on a per-layer basis, the gradient Y corresponding to the gradient output (e.g., loss with respect to the output data) is received from the subsequent layer at block 212. The gradient weight is determined at block 210 using the gradient output in order to update the weights for the layer. The gradient weight can be calculated using Equation (5) above. Note that in 246, blocks 214 and 212 are respectively referred to as gradient input and output as a matter of naming convention. In this context, the gradient input refers to the gradient passed to the shallower (preceding) layer and the gradient output refers to the gradient received from the deeper (subsequent) layer.

To calculate the gradient weight, the compressed weights for the particular layer can be retrieved as one or more matrices by loading the compressed weights from block 202 into memory. A temporary space (e.g., transitory memory) can be allocated for weight processing. At block 210, the compressed weights are decompressed to calculate the gradient weight. For example, the compressed exponent bits (cₗ) can be decompressed to return the uncompressed exponent bits (eₗ). The uncompressed weights can be generated in the form of one or more matrices within the temporary space (Ŵ), for example by merging/concatenating the uncompressed sign, exponent, and mantissa bits into a floating point matrix in the temporary space. The linear optimizer 216 can update the uncompressed weights in the temporary space, as described above. The updated weights can be used to calculate gradient X at block 214, corresponding to the gradient input for the preceding layer. Within the temporary space, the updated weights can be in the form of floating point matrices, where each element (e.g., each updated weight) therein can then be split into the sign, exponent, and mantissa components, as described above. The components can then be compressed (e.g., the exponent bits (eₗ) can be compressed losslessly (cₗ)), as described above, and returned to block 202 to update the compressed weights and for storage.

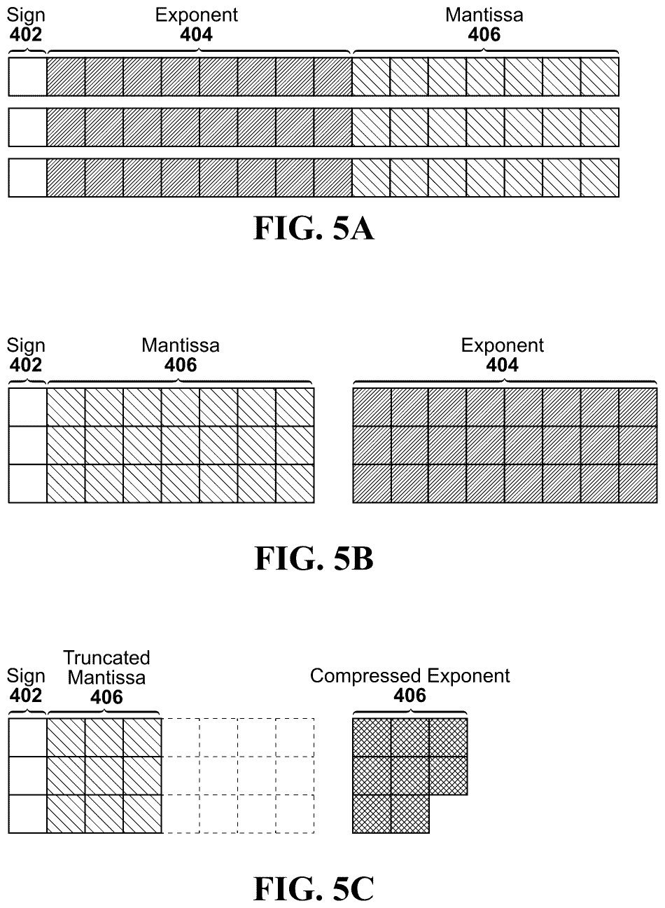

Note that while only the compression of the exponent bits is described above, the compression/decompression of the mantissa bits is also possible alongside the compression/decompression of the exponent bits. Further details regarding the compression of the mantissa bits are described herein with respect to FIG. 5A-5C.

240, 242, and 244 depict alternative approaches for model training. In FIG. 2B, blocks labelled as “Global” correspond to blocks operating in persistent memory. That is, the “Global” blocks and the associated data (e.g., weights, embeddings, gradients, etc.) persist within the memory throughout the entire training/inference process, even for unaffiliated layers. In contrast, blocks labelled as “Layer-wise” correspond to blocks which are loaded in memory temporarily. These blocks and the associated data only persist for the current layer for which calculations are being performed but are otherwise unloaded during processing at other layers.

As shown in FIG. 2B, the present disclosure (246) only requires the compressed weights (202) to be loaded at all times. In contrast, 240 requires input data (206), output data (208), weights (204), and gradient weights (210) to be loaded at all times. Similarly, 242 requires weights (204), and gradient weights (210) to be loaded at all time and 244 requires weights (204) to be loaded at all times. Accordingly, the present disclosure can present significant memory saving over 240, 242, and 244 in that the uncompressed weights are only loaded in memory on a per-layer basis and that only the compressed weights are loaded throughout.

While FIGS. 2A, 2B, 2C, and 3 generally relate to the training of a neural network, the same process can be applied analogously during inference. If back propagation is not desired during inference, the processes as described with respect to blocks 210-216 can be omitted. For example, for each layer, the network would be only required to receive the input data at block 206 and process input data at block 204 to generate the output data at block 208 by retrieving and decompressing the weights (204) for the layer from block 202 (e.g., no updates to the weights).

Note that the optimizer can also occupy a considerable amount of memory during training. To address this, many memory-efficient optimizers are under development to reduce the memory footprint of training. Advantageously, the disclosed method can be orthogonal to these optimization techniques, as more efficient optimizers can be seamlessly combined with the disclosed method for further memory saving. For example, as optimizers become more efficient, the disclosed lossless compression technique is expected to have the same performance while using less memory. Also note that memory-efficient optimizers and parameter-efficient training (as described above) cannot reduce the memory cost during inference. In contrast, the disclosed method can be utilized for both training and inference.

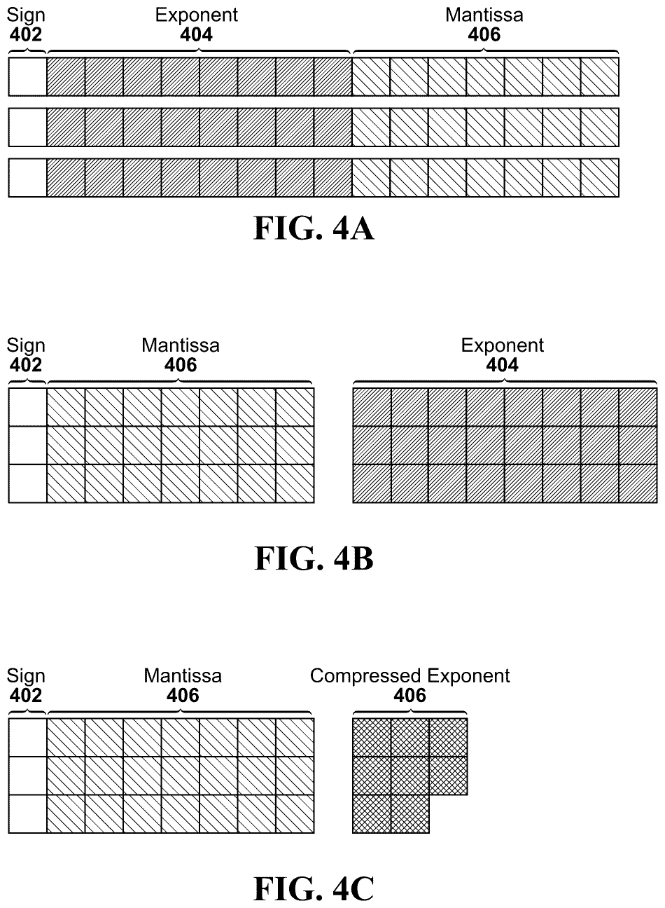

FIGS. 4A to 4C depict application of a lossless compression scheme used to compress an exponent of a floating point number representing a neural network weight, according to an example embodiment. In FIG. 4A, the weight is expressed as a floating point number, which may for example be the IEEE 754 standard. The weight comprises a combination of a sign bit 402, exponent bits 404, and a mantissa 406. As described above, the entropy for the exponent bits 404 is low relative to the higher entropy for the mantissa bits 406. Consequently, in FIG. 4B the exponent bits 404 are separated from the sign and mantissa bits 402, 406, and the exponent bits 404 are compressed as shown in FIG. 4C. Due to the exponent bits' 404 low entropy, lossless entropy encoding, such as ANS, may be used for compression. Other compression backends may be used in other embodiments, such as Deflate™ and Zstandard™. More generally, any entropy-based compression algorithm may be used to compress the exponents bits 404.

In particular, ANS can be used because it can be easily parallelized and achieves a high throughput with parallel execution, making it more suitable on deep learning accelerators like GPUs. Specifically, ANS encodes a sequence of symbols by treating them as base-n numbers. However, unlike the common numerical system that uses a uniform base for each digit, ANS treats every single digit with a different base [1/\hat{p}ᵢ], where \hat{p} is the frequency of symbols. As a result, it achieves a near-optimal compression rate by suing around 1/\hat{p}ᵢ bits for the i^{th} symbol.

FIG. 4A depicts each weight as a raw BF16 array comprising a 16-bit data structure. In FIG. 4B, in preparation for compressing the exponent bits 404, the array of FIG. 4A is replaced with two 8-bit arrays: a first 8-bit array representing the signed mantissa and comprising the sign bit 402 and the mantissa bits; and a second 8-bit array representing exponent bits 404. In FIG. 4C, the exponent bits 404 have been compressed using lossless entropy encoding, reducing the required storage for the three different exponents shown from 8 bits each to 3, 3, and 2 bits, respectively. As the three sets of compressed exponent bits 404 require only 8 bits of storage space, the compressed weights shown in FIG. 4C can be saved using only four 8-bit arrays as opposed to the six 8-bit arrays required to store the uncompressed weights as depicted in FIG. 4A. While the depicted embodiment shows the compressed exponent bits 404 for the three weights as taking 3, 3, and 2 bits, the exponent bits 404 in other embodiments may comprise a different number of bits, and/or the data structure used to store the weights may be something other than 8-bit arrays.

Note that the compression scheme depicted in FIG. 4A is a lossless compression scheme which can be used to compress the exponent bits of the floating point representations of weights. This compression scheme can be used for both network training and during inference, as described above with respect to FIGS. 2A, 2B, 2C, and 3.

As described above with respect to FIGS. 2A, 2B, 2C, and 3, the training of neural networks can be unaffected by the disclosed lossless compression. On the other hand, inference is known to be less sensitive to precision loss compared with training. This can enable further memory reduction for neural networks by reducing precision (e.g., of the weights). As described further herein, by perturbing each weight with a noise proportional to the weight magnitude, a small noise ratio is added, but with is little or no effect on the overall performance. Accordingly, further memory savings are possible by compressing the mantissa bits in a lossy way during inference. While the lossy compression can introduce noise, as noted, the noise has little effect on the actual model performance.

To consider the sensitivity of neural network weights to random perturbations, note that for each parameter or weight, there are two types of magnitudes: absolute and relative magnitudes. The former one represents the actual numerical error, whereas the second one is calculated based on the original value. For example, when the original value is −1.5, an absolute magnitude of 0.125 means that the perturbed range is [−1.5−0.125, −1.5+0.125]. On the other hand, a relative magnitude of 0.125 means the perturbed range is [−1.5*(1+0.125), −1.5*(1−0.125].

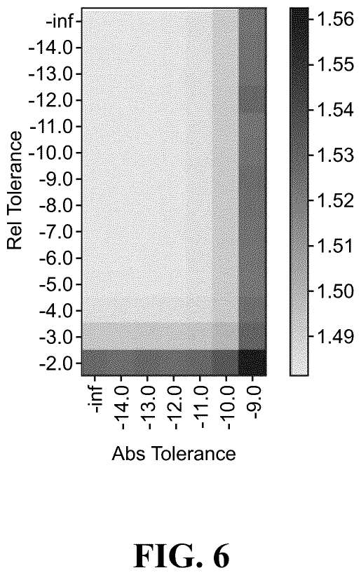

FIG. 6 depicts an example perturbation grid, corresponding to a graph representing tolerance for lossy compression, according to an example embodiment. For FIG. 6, each parameter was perturbed with controlled noises. Both the x- and y-axes are log-scale with base 2. For each cell, the maximum error between relative error and absolute value was chosen for perturbing. A random value was sampled from the perturbed range uniformly as the perturbation. The weight value was then set to the random sample. FIG. 6 shows that, empirically, neural networks are relatively insensitive to relative random perturbations, which accords with performing lossy mantissa compression through truncation. In particular, noise generally corresponds to relative change, and as depicted in FIG. 6, the model tends to tolerate the relative change rather than the absolute change. As such, it is possible to compress the weights in a lossy manner, thus introducing relatively insignificant noise, with minimal impact on the performance of the model.

FIGS. 5A to 5C depict application of a lossy compression scheme used to compress the mantissa of a floating point number representing a neural network weight, according to an example embodiment. FIGS. 5A and 5B are identical to FIGS. 4A and 4B, with the exponent bits 404 separated from the sign and mantissa bits 402, 406 due to their low entropy. FIG. 5C depicts a lossy compression scheme used to compress the mantissa bits 406. More particularly, the mantissa bits 406 are compressed through truncation, with precision set to 3 in FIG. 5C; different precisions corresponding to different degrees of truncation are available in additional embodiments.

Note that the lossy compression scheme may be more practical for use during inference. Further, the lossy compression scheme can be used in addition to or as an alternative to the lossless compression scheme, particularly for inference.

Generally, the lossy compression as disclosed herein corresponds to rounding and truncation of the mantissa to fewer bits. More specifically, consider the original floating-point number f, which has an exponent e and mantissa m. After rounding, the mantissa is denoted by \hat{m} and the resulting floating-point number is denoted by \hat{f}.

The rounding introduces an error which can be expressed as:

$$\vert f - \hat{f} \vert = \vert {2}^{e - 127} \cdot \frac{m}{{2}^{7}} - {2}^{e - 127} \cdot \frac{\hat{m}}{{2}^{7}} \vert = {2}^{e - 134} \cdot \vert m - \hat{m} \vert , \qquad ( 7 )$$

where e−127 interprets the exponent bits e as an integer, which can be either positive, negative, or 0. In the fraction m/2⁷, m can be the significand (e.g., an unsigned integer) and (exponent) 7 is the precision. Therefore, the relative error can be given by:

$$\frac{\vert f - \hat{f} \vert}{\vert f \vert} = \frac{{2}^{e - 134} \cdot \vert m - \hat{m} \vert}{{2}^{e - 134} \cdot \vert m \vert} = \frac{\vert m - \hat{m} \vert}{m} . \qquad ( 8 )$$

Assuming that rounding keeps the k most significant bits in m, the earliest point where \hat{m} could differ from the original number m is at the (k+1)th bit. This means that the maximum possible relative change introduced by this rounding may be ½^{k}. Given that the mantissa bits can be highly uniform as shown in FIGS. 1B and 1E, such a practice can resemble introducing weight perturbations based on relative magnitudes (as described above). Therefore, rounding of the mantissa can be justified as the effect on model performance is minimal.

In some embodiments, the sign and mantissa bits can be stored together (e.g., at block 202) as a signed integer to minimize the requests of memory write. Further, given that modern architectures are mostly byte (8-bit) addressable, in some embodiments, multiple such signed integers can be packed into a single byte for memory efficiency. To align with an 8-bit byte, the precision after rounding can be set to {0,1,3}, as described above with respect to FIGS. 5A-5C, ensuring that all the bits in a byte are utilized efficiently.

In some embodiments, a block-wise normalization technique, for example as described in [6], where a block is a chunk of weights that is stored contiguously in memory can be used. Such block-wise normalization can ensure that the weight with the largest magnitude in a block will always be normalized to 1, invariant to mantissa rounding and truncation. That is, the larger weights (e.g., the most important weights as determined by the network), may be subject to no compression or less compression. Additionally, it is possible to assign increasing levels of compression for weights of decreasing magnitude (e.g., importance). The normalization coefficient-which handles the mantissa while ignoring the exponent—can be stored with 8 bits, and can be used for de-normalization during the decompression of the weight. This approach may be generally applicable as larger weights can play a more important role in neural networks.

### Experiments

Table 1, below, summarizes experimental results testing the dynamic compression method. In particular, Table 1 represents GPU memory usage; byte-level PPL; word-level PPL; token-level PPL; and speed of the Llama-3™ 70B parameter model used to evaluate perplexities with forward passes in Wikitext™.

In Table 1, bolded values represent the best results for that column of the table. F0 represents that there are no mantissa (fraction) bits; F1 represents that only one mantissa (fraction) bit after truncation; BNB F4 represents the neural float 4-bit data type of with the bitsandbytes™ library; BNB INT4 represents linear quantization with the bitsandbytes™ library; and “DQ” means the double quantization technique is used. Table 1 shows that an embodiment of the dynamic compression method with no mantissa bits uses the least amount of memory.

TABLE 1
Experimental results

| | | Byte- | Word- | Token- | |
|---|---|---|---|---|---|
| | Memory | level | level | level | Speed |
| | (GiB) | PPL | PPL | PPL | (iter/s) |
| BNB NF4 | 40.09 | 1.331 | 4.612 | 3.583 | 0.44 |
| BNB DQ NF4 | 37.13 | 1.331 | 4.618 | 3.587 | 0.46 |
| BNB int4 | 40.09 | 1.362 | 5.229 | 3.978 | 0.46 |
| BNB DQ int4 | 37.13 | 1.362 | 5.231 | 3.980 | 0.46 |
| Dynamic | 32.41 | 1.448 | 7.250 | 5.227 | 0.34 |
| Compression | | | | | |
| Method (F0) | | | | | |
| Dynamic | 36.05 | 1.411 | 6.340 | 4.674 | 0.34 |
| Compression | | | | | |
| Method (F0) | | | | | |
| Dynamic | 41.10 | 1.335 | 4.703 | 3.642 | 0.21 |
| Compression | | | | | |
| Method (F1) | | | | | |
| Dynamic | 43.80 | 1.325 | 4.515 | 3.520 | 0.22 |
| Compression | | | | | |
| Method (F1) | | | | | |

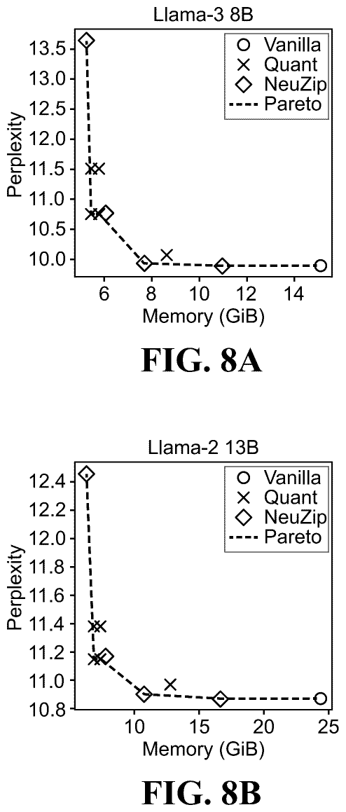

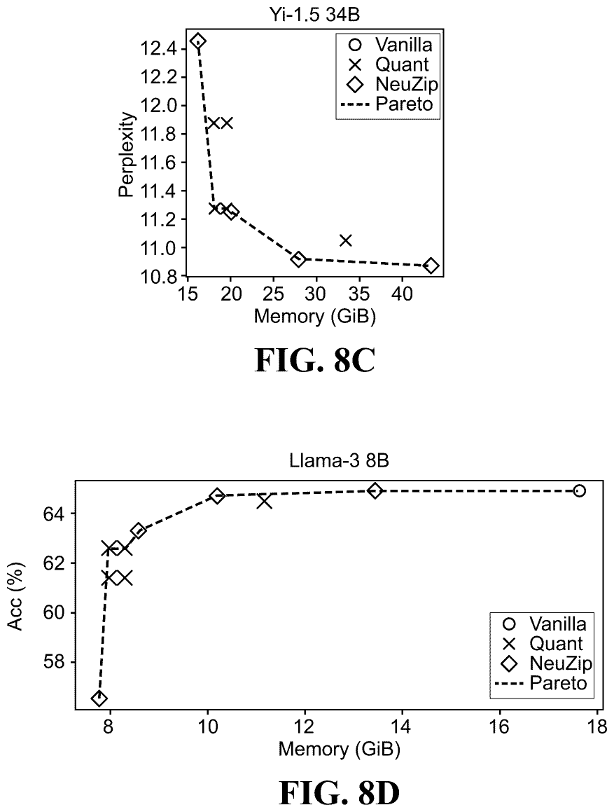

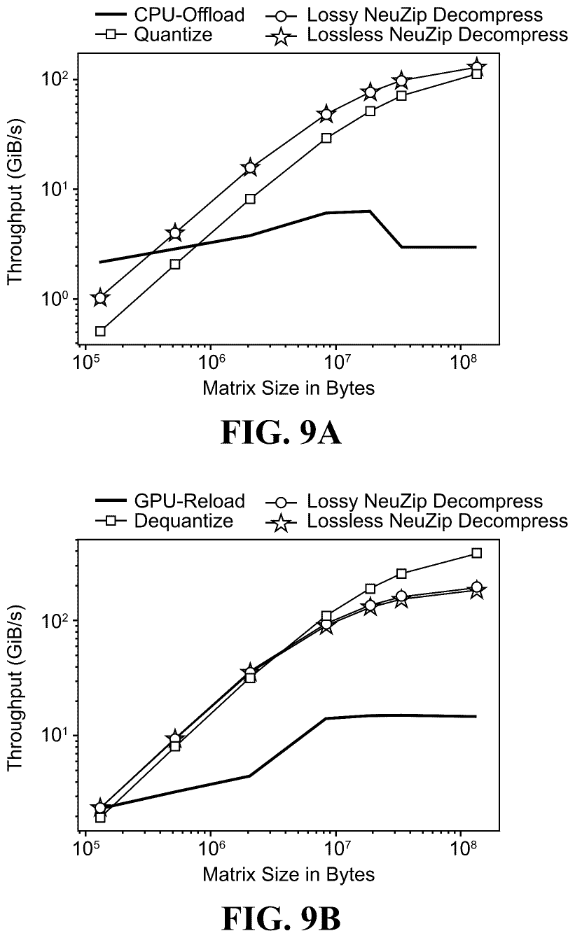

Additional experimental results are provided below and described with respect to FIGS. 8A-8D, 9A, and 9B, according to example embodiments only. Two transformer-based models were tested: decoder-only and encoder-decoder models. All experiments were conducted on RTX™ A6000 GPUs where the uncompressed data type is BFloat16. As used in FIGS. 8A-8D, 9A, and 9B and described below, the disclosed method is denoted as “Neuzip”.

### Lossless Compression for Pre-Training

The decoder-only models were used to evaluate the disclosed method on the pre-training task. Three models with different sizes were selected to study the scaling effect, including GPT-Neo™ 2.7B, Llama-3™ 8B, and Llama-2™ 13B. For fair comparison, all competing alternative methods were initialized with the same random weights as the disclosed method. The task was selected as language modeling, requiring the model to predict the next token given the context. The chosen dataset is the Wikitext-2™ dataset, where each data sample is a fixed-length sequence from an article on Wikipedia™. The length was set to 1024. For each experiment, the loss (negative log-likelihood) on unseen samples is shown. To study memory saving, the peak memory usage for each run during the training process is shown. The numbers are shown in gibibyte (GiB, 1024³ bytes). The speed by the number of iterations per second are also shown to demonstrate the time-efficiency of each method. The vanilla SGD update was applied to all runs for efficiency. The activation checkpointing technique was also enabled by default. It is worth noting that pre-training these large models to the optimal performance can be extremely computationally expensive. Given that the disclosed training method is lossless, the models were trained for 1 epoch. The same hyper-parameters were used for all runs. Here, only the lossless compression is applied.

Table 2 below shows the comparative performance of various methods on the language modeling task. The loss numbers are calculated on the validation set with the cross-entropy loss. Memory is reported in GiB (1024³ B). Speed represents the number of iterations per second. The bold numbers represent the top results.

The vanilla training method, where only the activation checkpointing was applied (shown in 242 of FIG. 2B), was first tested. As shown, the vanilla training requires the highest amount of memory because it stores the uncompressed weights and gradients for all layers. The LOMO technique was also tested, which promptly updates the weights in a layer-by-layer fashion (shown in 244 of FIG. 2B). This allows LOMO to reuse a buffer to store the gradients for each layer. As a result, LOMO approximately reduces the peak memory usage by the size of a model.

In comparison, the disclosed method additionally reduces more than 20% of memory compared with LOMO, accounting for a total memory reduction of more than 50%. Notably, the disclosed method reduces the peak memory of training a Llama-2™ 13B model to less than 20 GB, enabling training a 13B model on consumer-grade GPUs without any precision loss.

TABLE 2
Pre-training decoder-only models on the language modeling task

| | GPT-Neo-XL ™ 2.7B | | | Llama-3 ™ 8B | | | LLama-2 ™ 13B | | |
|---|---|---|---|---|---|---|---|---|---|
| Name | Loss | Mem | Speed | Loss | Mem | Speed | Loss | Mem | Speed |
| Vanilla | 8.81 | 11.22 | 0.96 | 8.61 | 30.97 | 0.77 | — | OOM | — |
| LOMO | 8.81 | 6.97 | 0.94 | 8.61 | 19.47 | 0.78 | 9.10 | 26.26 | 0.49 |
| NeuZip (Lossless) | 8.81 | 5.54 | 0.70 | 8.61 | 15.25 | 0.45 | 9.10 | 18.58 | 0.28 |

### Lossless Compression for Fine-Tuning

A benefit of using lossless compression can be in retaining the pre-trained weights without any information loss. A fine-tuning experiment was conducted with encoder-decoder models to test the performance of the disclosed method on broader architectures. In particular, three T5 models were chosen: T5 1B, T5 3B, and T5 11B, where the pre-trained parameters are used for initialization. The T5 models were pre-trained on the C4 dataset, filtered to contain natural language only. To avoid data leaks from pre-training, a non-natural language generation dataset was used for fine-tuning. Specifically, a public Structured Query Language (SQL) generation dataset was used as the test bed. For each sample, the model was required to generate the SQL command from a human question. For example, the question could be “CREATE TABLE head (age INTEGER). How many heads of the departments are older than 56?”. The model is expected to generate “SELECT COUNT (*) FROM head WHERE age >56”. The question and response were fed into the encoder and decoder, respectively. The objective was to minimize the cross-entropy loss on the response. Similar to the pre-training experiments, the learning rate was swept from 10⁻³ to 3×10⁻¹ for each run. After fine-tuning, the models were used for generation on the validation set with greedy decoding. The generated SQL commands were then compared with the ground truths by SacreBLEU™, a metric that evaluates the similarity between corpora based on precision scores.

Table 3 below shows the comparative performance of various methods on the SQL generation task. All baselines in the pre-training experiment are included in this table. Note that the same BLEU scores were achieved for each model. Specifically, the disclosed method was able to train an 11B model within 24 GB. The BLEU scores were calculated with SacreBLEU™. Memory is reported in GiB (1024³ B). Speed represents the number of iterations per second. The bold numbers represent the top results.

For fine-tuning, it is possible to apply other memory-efficient training techniques. For example, QLoRA compresses the pre-trained model by using low-precision data types and trains the LoRA modules only. In this experiment, the widely used quantization data types for QLoRA were used, including INT8, FP4, and NF4. The LoRA modules were applied on all linear layers, where every LoRA rank was set to 8 to control the memory usage. As shown in the second half of Table 3, all other quantization methods underperform the disclosed method in terms of both generation quality and memory usage. In terms of time efficiency, some quantization methods were slower than others, but in general, they were in the same magnitude as the disclosed method. Overall, the disclosed method achieves the least memory usage while maintaining the highest performance.

TABLE 3
Fine-tuning encoder-decoder models on the SQL generation task

| | T5 1B | | | T5 3B | | | T5 11B | | |
|---|---|---|---|---|---|---|---|---|---|
| Name | BLEU | Mem | Speed | BLEU | Mem | Speed | BLEU | Mem | Speed |
| Vanilla | 79.9 | 3.82 | 3.69 | 85.1 | 11.32 | 2.43 | — | OOM | — |
| LOMO | 79.9 | 2.75 | 3.68 | 85.1 | 7.07 | 2.47 | 82.3 | 25.95 | 0.69 |
| NeuZip (Lossless) | 79.9 | 2.39 | 2.02 | 85.1 | 5.21 | 1.33 | 82.3 | 20.68 | 0.46 |
| QLoRA INT8 | 70.4 | 5.84 | 1.11 | 72.1 | 11.54 | 1.12 | 63.5 | 33.36 | 0.37 |
| QLoRA FP4 | 70.1 | 3.63 | 1.70 | 72.1 | 7.35 | 1.74 | 63.3 | 22.73 | 0.58 |
| QLoRA FP4 ² | 70.6 | 3.61 | 1.63 | 72.0 | 7.27 | 1.61 | 60.6 | 22.38 | 0.57 |
| QLoRA NF4 | 70.4 | 3.63 | 1.83 | 71.2 | 7.35 | 1.65 | 59.4 | 22.73 | 0.57 |
| QLoRA NF4 ² | 70.5 | 3.61 | 1.64 | 71.2 | 7.07 | 1.57 | 57.9 | 22.38 | 0.57 |

### Lossy Compression for Inference

The inference process is less sensitive in precision loss, which provides an opportunity for compressing mantissa in a lossy fashion during inference. The disclosed method was tested with both decoder-only and encoder-decoder architectures. For the decoder-only models, LLama-3™ 8B, LLama-2™ 13B, and Yi-1.5™ 34B models were used. For the encoder-decoder architecture, the T5 1B, 3B, and 11B models were used. Since all decoder-only models were trained for language modeling, their performance was evaluated with language modeling tasks. Specifically, all methods were tested on the Wikitext-2™ validation set, where each sequence consists of 1024 tokens. On the other hand, the encoder-decoder models (T5 series) contained multiple tasks in pre-training. Since they excel at zero-shot translation, they were evaluated on the WMT14 En-De translation task, where each source sentence was prepended with “translate from English to German:” based on the pre-training format. Following a standard evaluation pipeline for lossy compression, all models were evaluated with the perplexity metric, which is sensitive to how distorted the compressed model is.

The results for decoder-only and encoder-decoder models are shown in Tables 4A and 4B, respectively, which show comparisons of the various methods in performing language modeling tasks. In Tables 4A and 4B, “PPL” represents the perplexity values. Memory is reported in GiB. Speed represents the number of iterations per second. The bold numbers represent the top results, whereas the underlined numbers are the second-best ones. With regard to Table 4A, the perplexities are adjusted to word level to compare across different tokenizations. With regard to Table 4B, since all models used the same tokenizer, perplexities are shown at the token level for simplicity. The vanilla (uncompressed BFloat16) models achieved the best perplexity scores in all experiments at a cost of the excessive memory usage. For quantization methods, INT8, FP4, and NF4 data types were chosen. In general, quantization methods suffered from notable perplexity degradation. Although the INT8 variant managed to better preserve the perplexity, it uses around 50% more memory compared with other quantization methods.

Three different levels of precision were tested for the disclosed method with 0-bit, 1-bit, and 3-bit mantissa preserved. These values were chosen for better alignment in 8-bit byte arrays. All these variants used a block size of 512 for normalization. A version of the disclosed method with the full 7-bit mantissa and lossless compression of the exponents is also included for comparison. As shown in Tables 4A and 4B, the disclosed method (using lossy compression) demonstrated a spectrum of memory saving and performance preservation. The 0-bit variant attained the best memory efficiency in all experiments, whereas the lossless 7-bit variant obtained the best perplexity scores. Notably, the 3-bit variant achieved nearly lossless performance in all experiments while using less than 50% memory compared with the uncompressed model.

TABLE 4A
Comparisons of decoder-only models on the language modeling task

| | Llama-3 ™ 8B | | | Llama-2 ™ 13B | | | Yi-1.5 ™ 34B | | |
|---|---|---|---|---|---|---|---|---|---|
| Name | PPL | Mem | Speed | PPL | Mem | Speed | PPL | Mem | Speed |
| Vanilla | 9.89 | 15.08 | 5.07 | 10.87 | 24.36 | 3.59 | — | OOM | — |
| Quant INT8 | 10.07 | 8.63 | 3.54 | 10.97 | 12.74 | 2.27 | 10.87 | 33.41 | 1.13 |
| Quant FP4 | 11.51 | 5.77 | 3.45 | 11.38 | 7.37 | 1.87 | 11.57 | 19.54 | 1.75 |
| Quant NF4 | 10.75 | 5.77 | 3.38 | 11.15 | 7.37 | 1.83 | 11.06 | 19.54 | 1.67 |
| Quant FP4 ² | 11.50 | 5.44 | 3.41 | 11.38 | 6.87 | 1.86 | 11.57 | 18.11 | 1.61 |
| Quant NF4 ² | 10.75 | 5.44 | 3.34 | 11.15 | 6.87 | 1.81 | 11.06 | 18.11 | 1.54 |
| NeuZip (0-bit) | 13.64 | 5.24 | 3.44 | 12.46 | 6.30 | 1.87 | 12.06 | 16.20 | 0.94 |
| NeuZip (1-bit) | 10.77 | 6.05 | 3.38 | 11.17 | 7.77 | 1.86 | 11.04 | 20.14 | 0.93 |
| NeuZip (3-bit) | 9.93 | 7.70 | 3.38 | 10.90 | 10.73 | 1.84 | 10.76 | 27.92 | 0.93 |
| NeuZip (7-bit, | 9.89 | 10.95 | 3.39 | 10.87 | 16.66 | 1.84 | 10.72 | 43.40 | 0.94 |
| lossless) | | | | | | | | | |

TABLE 4B
Comparisons of encoder-decoder models on the language modeling task

| | T5 1B | | | T5 3B | | | T5 11B | | |
|---|---|---|---|---|---|---|---|---|---|
| Name | PPL | Mem | Speed | PPL | Mem | Speed | PPL | Mem | Speed |
| Vanilla | 2.614 | 1.37 | 23.73 | 2.571 | 5.31 | 19.86 | 2.568 | 21.06 | 6.20 |
| Quant INT8 | 2.615 | 1.28 | 4.24 | 2.573 | 4.94 | 4.28 | 2.569 | 19.59 | 2.58 |
| Quant NF4 | 2.632 | 1.08 | 11.64 | 2.588 | 4.12 | 11.82 | 2.579 | 16.28 | 4.48 |
| Quant FP4 | 2.646 | 1.08 | 11.92 | 2.594 | 4.12 | 11.99 | 2.585 | 16.28 | 4.59 |
| Quant FP4 ² | 2.646 | 1.05 | 10.39 | 2.594 | 4.03 | 9.72 | 2.585 | 15.93 | 4.52 |
| Quant NF4 ² | 2.632 | 1.05 | 10.39 | 2.587 | 4.03 | 9.96 | 2.579 | 15.93 | 4.39 |
| NeuZip (0-bit) | 2.731 | 0.40 | 11.82 | 2.668 | 1.41 | 8.70 | 2.651 | 5.35 | 3.24 |
| NeuZip (1-bit) | 2.641 | 0.48 | 11.68 | 2.591 | 1.78 | 8.61 | 2.581 | 6.65 | 3.21 |
| NeuZip (3-bit) | 2.614 | 0.66 | 11.99 | 2.574 | 2.42 | 8.60 | 2.569 | 9.27 | 3.19 |
| NeuZip (7-bit, | 2.614 | 0.99 | 11.55 | 2.571 | 3.73 | 8.77 | 2.568 | 14.46 | 3.23 |
| lossless) | | | | | | | | | |

### Analysis

Note that the performance can often be decreased with less memory usage. FIGS. 8A-8C depict the trade-off between memory and performance for different methods when implemented using different models. This trade-off between memory and performance and the corresponding quantization methods are shown as graphs in FIGS. 8A-8C. Note that the optimal methods are the ones on the Pareto frontier, corresponding to the bottom-left of the graph. As shown in FIGS. 8A-8C, three out of four variants of the disclosed method were on the Pareto frontier, with the remaining one staying fairly close to the frontier. On the other hand, there was only one quantization technique that lied on the Pareto frontier. This result demonstrates that the disclosed method generally achieves a better memory-performance trade-off than quantization. In addition to measuring the perplexity, FIG. 8D depicts the end-to-end performance on the MMLU dataset for different methods when implemented using different models. For FIG. 8D, the theoretical optimal point is at the to left corner of the graph. As depicted in FIG. 8D, all variants of the disclosed method were on the Pareto frontier, suggesting superior trade-off between memory and performance.

To analyze the effect of block size in lossy compression, normalization was applied to variants of the disclosed method using lossy compression to ensure that the weight with the largest absolute value would not be affected by truncation. To evaluate the effect of block size in this experiment, a giant model, Llama-3™ 70B was evaluated on the Wikitext-2™ dataset. Table 5 below shows the effect of block size on model performance. As shown in Table 5, a smaller block size can lead to better performance at the cost of compromising memory efficiency due to the overhead of storing normalization coefficients. Therefore, the block-wise normalization can provide a more fine-grained trade-off between memory and performance by varying the block size.

TABLE 5
Effect of block size on model performance

| | Block 32 | | Block 64 | | Block 128 | | Block 256 | | Block 512 | |
|---|---|---|---|---|---|---|---|---|---|---|
| Name | PPL | Mem | PPL | Mem | PPL | Mem | PPL | Mem | PPL | Mem |
| NeuZip (0-bit) | 6.341 | 35.7 | 6.694 | 34.6 | 6.853 | 34.2 | 7.639 | 33.8 | 7.104 | 33.5 |
| NeuZip (1-bit) | — | OOM | 4.611 | 42.7 | 4.662 | 42.2 | 4.640 | 41.8 | 4.649 | 41.4 |

The throughput of matrix compression and decompression for the disclosed method was also evaluated, in comparison with the throughput of matrix quantization and de-quantization based on the NF4 data type, using the popular library bitsandbytes™. The CPU-offloading technique was also included as a baseline, which lowered the GPU memory pressure by transferring data to CPU and reloading the data to GPU when needed. FIGS. 9A and 9B depict the throughput of matrix processing in GiB/s when the matrix size was varied from 105 to 108 bytes. In particular, FIG. 9A depicts comparison of CPU-offloading, quantization, and the disclosed method using lossy and lossless compression; FIG. 9B depicts comparison of GPU-reloading, de-quantization, and the disclosed method using lossy and lossless compression.

As shown in FIG. 9A, CPU-offloading was generally slow across different sizes of matrices. This was due to the bottleneck of CPU-GPU communication through PCIe. For quantization, the bitsandbytes™ package has been highly optimized for GPU, and its throughput was one magnitude higher than the CPU-offloading technique when the matrix size was large. Note that the disclosed method achieved the highest throughput for compression among all methods (FIG. 9A) and exhibited a high throughput for decompression similar to de-quantization (FIG. 9B). These results suggest that while the disclosed method can cause overhead compared with uncompressed vanilla models, it can nevertheless still be highly efficient in practice.

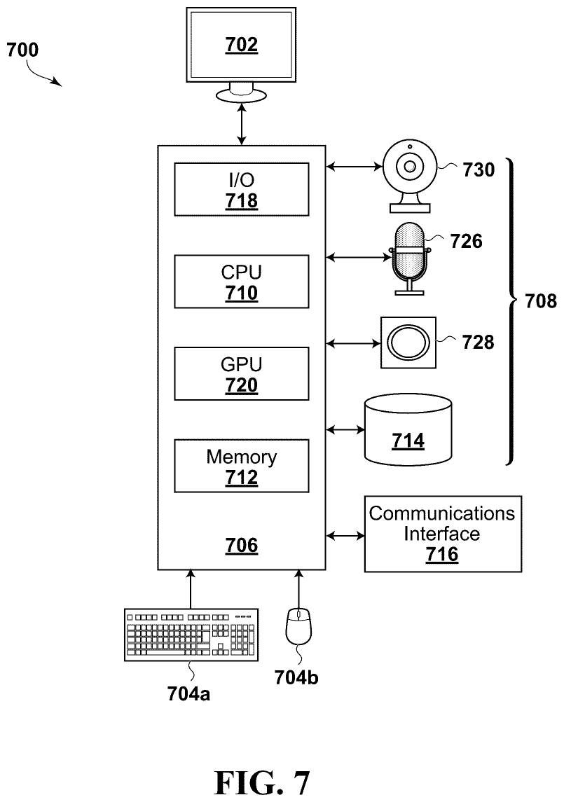

An example computer system in respect of which a method for training or performing inference using a neural network having weights that are dynamically compressed and decompressed described above may be implemented is presented as a block diagram in FIG. 7. The example computer system is denoted generally by reference numeral 700 and includes a display 702, input devices in the form of keyboard 704a and pointing device 704b, computer 706 and external devices 708. While pointing device 704b is depicted as a mouse, it will be appreciated that other types of pointing device, or a touch screen, may also be used.

The computer 706 may contain one or more processors or microprocessors, such as a central processing unit (CPU) 710. The CPU 710 performs arithmetic calculations and control functions to execute software stored in a non-transitory internal memory 712, preferably random access memory (RAM) and/or read only memory (ROM), and possibly additional memory 714. The additional memory 714 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 714 may be physically internal to the computer 706, or external as shown in FIG. 7, or both.

The one or more processors or microprocessors are examples of suitable processing units, which may additional or alternatively comprise an artificial intelligence accelerator, programmable logic controller, a microcontroller (which comprises both a processing unit and a non-transitory computer readable medium), AI accelerator, or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal and/or additional memory 714 for execution by the one or more processors or microprocessors to effect neural network pre-training, training, or use of a trained network for inference.

The computer system 700 may also include other similar means for allowing computer programs or other instructions to be loaded. Such means can include, for example, a communications interface 716 which allows software and data to be transferred between the computer system 700 and external systems and networks. Examples of communications interface 716 can include a modem, a network interface such as an Ethernet card, a wireless communication interface, or a serial or parallel communications port. Software and data transferred via communications interface 716 are in the form of signals which can be electronic, acoustic, electromagnetic, optical or other signals capable of being received by communications interface 716. Multiple interfaces, of course, can be provided on a single computer system 700.

Input and output to and from the computer 706 is administered by the input/output (I/O) interface 718. This I/O interface 718 administers control of the display 702, keyboard 704a, external devices 708 and other such components of the computer system 700. The computer 706 also includes a GPU 720. The latter may also be used for computational purposes as an adjunct to, or instead of, the CPU 710, for mathematical calculations, particularly but not limited to the context of neural network training.

The external devices 708 include a microphone 726, a speaker 728 and a camera 730. Although shown as external devices, they may alternatively be built in as part of the hardware of the computer system 700.

The various components of the computer system 700 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a file” or “the file” does not exclude embodiments in which multiple files are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Noam Shazeer and Mitchell Stern. Adafactor: Adaptive learning rates with sublinear memory cost. arXiv preprint arXiv: 1804.04235, 2018.
[2] Anonymous. Flora: Low-rank adapters are secretly gradient compressors. In Forty-first International Conference on Machine Learning, 2024. URL https://openreview.net/forum?id=uubBZKM99Y.
[3] Tianqi Chen, Bing Xu, Chiyuan Zhang, and Carlos Guestrin. Training deep nets with sublinear memory cost. arXiv preprint arXiv: 1604.06174, 2016.
[4] Tim Dettmers, Artidoro Pagnoni, Ari Holtzman, and Luke Zettlemoyer. Qlora: Efficient finetuning of quantized llms. Advances in Neural Information Processing Systems, 36, 2024.
[5] Jarek Duda. Asymmetric numeral systems: entropy coding combining speed of huffman coding with compression rate of arithmetic coding. arXiv preprint arXiv: 1311.2540, 2013.
[6] T. Dettmers, A. Pagnoni, A. Holtzman, and L. Zettlemoyer. QLoRA: Efficient finetuning of quantized LLMs. In NeurIPS, 2023. URL https://openreview.net/forum?id=OUIFPHEgJU.

1. A method for implementing data compression for training or performing inference using a neural network, the method comprising, for each of at least one layer of the neural network:
(a) retrieving compressed weights for the layer of the neural network, wherein the compressed weights correspond to neurons in the layer;
(b) decompressing the compressed weights to generate decompressed weights; and
(c) processing input data for the layer using the neurons and the decompressed weights to generate output data for the layer.

2. The method of claim 1,
(a) wherein, during forward propagation, the input data comprises input embeddings and the output data comprises output embeddings; and
(b) wherein the input embeddings and the output embeddings are for generating neural network output.

3. The method of claim 1,
(a) wherein, during back propagation, the input data comprises input gradients and the output data comprises output gradients; and
(b) wherein the input gradients and the output gradients are for updating the neural network.

4. The method of claim 1, wherein the compressed weights and the decompressed weights are floating point numbers.

5. The method of claim 1, further comprising:
(a) retrieving the decompressed weights of the neural network;
(b) splitting each of the decompressed weights into sign bits, exponent bits, and mantissa bits;
(c) compressing the exponent bits and/or the mantissa bits to generate the compressed weights; and
(d) storing the compressed weights for use during neural network operation.

6. The method of claim 1, wherein the decompressed weights are allocated to a temporary memory space only active during the operation of the layer.

7. The method of claim 1, further comprising: concatenating the decompressed weights into floating point numbers for the processing.

8. The method of claim 1, further comprising: labeling and/or storing input data and/or output data for back propagation.

9. The method of claim 1, further comprising:
(a) updating the decompressed weights using an optimizer;
(b) compressing the decompressed weights to generate updated compressed weights; and
(c) updating the compressed weights using the updated compressed weights.

10. The method of claim 9, further comprising: splitting the decompressed weights into sign bits, exponent bits, and mantissa bits.

11. The method of claim 1,
(a) wherein each of the uncompressed weights comprises exponent bits and mantissa bits, and
(b) wherein the each of the compressed weights comprises exponent bits compressed using entropy-based lossless compression.

12. The method of claim 11, wherein the compressed weights comprise mantissa bits compressed using lossy compression.

13. The method of claim 12, wherein the lossy compression comprises truncating the mantissa.

14. The method of claim 11,
(a) wherein the exponent bits for a plurality of the weights share a single array when compressed, and
(b) wherein the mantissa bits for the plurality of the weights are respectively stored in a number of arrays corresponding to a number of the plurality of the weights.

15. The method of claim 11, wherein the lossless compression is performed using an asymmetric numeral system algorithm.

16. A method for training a neural network, the method comprising, for each of at least one layer of the neural network:
(a) retrieving compressed weights for the layer of the neural network, wherein the compressed weights correspond to neurons in the layer;
(b) decompressing the compressed weights to generate decompressed weights;
(c) updating the decompressed weights using first gradients for the layer; and
(d) processing the first gradients for the layer using the neurons and the decompressed weights to generate second gradients for the layer;
(e) compressing the decompressed weights to generate updated compressed weights; and
(f) updating the compressed weights using the updated compressed weights.

17. The method of claim 16, wherein the compressed weights comprise compressed exponent bits.

18. A method for performing inference using a neural network, the method comprising, for each of at least one layer of the neural network:
(a) retrieving compressed weights for the layer of the neural network, wherein the compressed weights correspond to neurons in the layer;
(b) decompressing the compressed weights to generate decompressed weights; and
(c) processing first embeddings input to the layer using the neurons and the decompressed weights to generate second embeddings for the layer,
(d) wherein the compressed weights comprise compressed exponent bits and/or compressed mantissa bits.

19. A system comprising at least one processing unit configured to perform a method for implementing data compression for training or performing inference using a neural network, the method comprising, for each of at least one layer of the neural network:
(a) retrieving compressed weights for the layer of the neural network, wherein the compressed weights correspond to neurons in the layer;
(b) decompressing the compressed weights to generate decompressed weights; and
(c) processing input data for the layer using the neurons and the decompressed weights to generate output data for the layer.

20. At least one non-transitory computer readable medium having stored thereon computer program code that is executable by at least one processor and that, when executed by the at least one processor, causes the at least one processor to perform a method for implementing data compression for training or performing inference using a neural network, the method comprising, for each of at least one layer of the neural network:
(a) retrieving compressed weights for the layer of the neural network, wherein the compressed weights correspond to neurons in the layer;
(b) decompressing the compressed weights to generate decompressed weights; and
(c) processing input data for the layer using the neurons and the decompressed weights to generate output data for the layer.
